(19) United States
(12) Patent Application Publication
(10) Pub. No.: US 2009/0248595 A1
(43) Pub. Date: Oct. 1, 2009

(54) NAME VERIFICATION USING MACHINE LEARNING

(76) Inventors: Yumao Lu, San Jose, CA (US); Nawaaz Ahmed, San Francisco, CA (US); Fuchun Peng, Sunnyvale, CA (US); Benoit Dumoulin, Montreal (CA)

Correspondence Address: YAHOO C/O MOFO PALO ALTO, 755 PAGE MILL ROAD, PALO ALTO, CA, 94304, US

(21) Appl. No.: 12/060,154

(22) Filed: Mar. 31, 2008

(51) Int. Cl. G06F 15/18

(52) U.S. Cl. 706/12

(57) ABSTRACT

Computer-enabled methods, apparatus, and computer-readable media are provided for verifying that a given network name, such as a URL, is an official, e.g., registered, approved, or otherwise officially recognized, network name that refers to or identifies a principal, such as a business. These techniques involve receiving a principal name and a given network name, receiving at least one feature attribute from at least one database of feature attributes, wherein the at least one feature attribute comprises a characteristic of the principal name or a characteristic of the network name, and invoking a logistic regression method to generate a probability, based upon the at least one feature attribute, that the given network name is an official network name for the principal name. The logistic regression method may include a gradient boosting tree model that generates the probability based upon the at least one feature attribute.

### BACKGROUND

1. Field

The present application relates generally to machine learning, and more specifically to machine learning techniques for verifying the authenticity of names in distributed computing environments.

2. Related Art

Online information providers such as Yahoo!® Local publish local business and service provider information. Information providers obtain such information by allowing local businesses and service providers to submit their business name, location, homepage, and other information. The online information provider provides the information to users in response to search queries, such as queries submitted to the Yahoo! Local web site.

A significant amount of submitted business information is not accurate. The business information may be intentionally inaccurate (e.g., spam) or unintentionally inaccurate (e.g., an erroneous submission, such as an incorrect URL or business name). Editorial tests show that approximately 85% of submitted business URLs may be incorrect. A common error is that the submitted URL is not the correct business homepage for the submitted business name. The existing solution to the problem of inaccurate URL's and business names involves hiring human editors to verify large numbers of URL'S. Human judgments, however, are expensive, time consuming and inaccurate. It would be desirable, therefore, to have an automated system for identifying and correcting inaccurate URL's and business names with reduced human intervention.

### SUMMARY

In general, in a first aspect, the invention features a computer-enabled method that includes receiving a principal name and a given network name, receiving at least one feature attribute from at least one database of feature attributes, wherein the at least one feature attribute comprises a characteristic of the principal name, a characteristic of the network name, or a combination thereof, and invoking a logistic regression method to generate a probability, based upon the at least one feature attribute, that the given network name is an official network name for the principal name.

Embodiments of the invention may include one or more of the following features. The network name may include a Uniform Resource Locator, a network host name, a network address, an electronic mail address, a user logic name, or a combination thereof. The principal name may include a name of an organization or a name of an individual. The principal name may include a name of a business. The logistic regression method may include a gradient boosting tree model that generates the probability based upon the at least one feature attribute. Receiving at least one feature attribute may include invoking a search engine to search for at least one document that includes the principal name, receiving a top network name from the search engine, wherein the top network name refers to a top-ranked document selected from the at least one document that includes the principal name, acquiring from a feature extractor database at least one first competitive feature that corresponds to the given network name, acquiring from the feature extractor database at least one second competitive feature that corresponds to the top network name, and generating the at least one feature attribute based upon application of a feature comparison operator to the at least one first competitive feature and the at least one second competitive feature.

The at least one first competitive feature and the at least one second competitive feature may each include a page quality score, a spam score, a word score, or a combination thereof. The at least one first competitive feature may include a click feature, a document feature, a web link topology feature, or a combination thereof. The click feature may include a click ratio of the number of clicks on a particular network name for a query to the total number of clicks for the query. The document feature may include a measure of document quality, a number of misspelled words, a length of the document, a spam score of the document, or a combination thereof.

The web link topology feature may include the entropy of an inbound link distribution, wherein the distribution comprises a histogram of inbound anchor text of a destination network name. Receiving at least one feature attribute may include receiving unigram, bigram, or trigram information, or a combination thereof, for the principal name from a local information database, and generating the at least on feature attribute based upon at least one of the unigram, bigram, and/or trigram information.

Receiving at least one feature attribute may include receiving at least one semantic feature, wherein the at least one semantic feature comprises a vertical knowledge feature, a term variation, a semantic matching feature, or a combination thereof, and generating the at least on feature attribute based upon the at least one semantic feature.

In general, in a second aspect, the invention features a computer-enabled method that includes receiving a principal name and a given network name, invoking a search engine to search for at least one document that includes the principal name, receiving a top network name from the search engine, wherein the top network name refers to a top-ranked document selected from the at least one document that includes the principal name, acquiring from a feature extractor database at least one first competitive feature that corresponds to the given network name, acquiring from the feature extractor database at least one second competitive feature that corresponds to the top network name, generating at least one relative feature based upon application of a feature comparison operator to the at least one first competitive feature and the at least one second competitive feature, determining at least one semantic feature of the principal name, and invoking a logistic regression method to generate a probability, based upon the at least one relative feature and the at least one semantic feature, that the given network name is an official network name for the principal name.

Embodiments of the invention may include one or more of the following features. The logistic regression method may include a gradient boosting tree model that generates the probability based upon the relative and semantic features. The at least one first competitive feature and the at least one second competitive feature may each include a page quality score, a spam score, a word score, or a combination thereof. The at least one first competitive feature may include a click feature, a document feature, a web link topology feature, or a combination thereof.

The click feature may include a click ratio of the number of clicks on a particular network name for a query to the total number of clicks for the query. The document feature may include a measure of document quality, a number of misspelled words, a length of the document, a spam score of the document, or a combination thereof. The web link topology feature may include the entropy of an inbound link distribution, wherein the distribution comprises a histogram of inbound anchor text of a destination network name. Determining at least one semantic feature of the principal name may include receiving unigram, bigram, or trigram information, or a combination thereof, for the principal name from a local information database. Determining at least one semantic feature of the principal name may include receiving the at least one semantic feature, wherein the at least one semantic feature comprises a vertical knowledge feature, a term variation, a semantic matching feature, or a combination thereof.

In general, in a third aspect, the invention features an apparatus having logic operable to perform operations that correspond to the computer-enabled methods described above, and in a fourth aspect, the invention features a computer-readable medium comprising instructions that correspond to the computer-enabled methods described above.

### BRIEF DESCRIPTION OF THE DRAWINGS

The present application can be best understood by reference to the following description taken in conjunction with the accompanying drawing figures, in which like parts may be referred to by like numerals:

FIG. 1 illustrates a network name authenticity verifier in accordance with embodiments of the invention.

FIG. 2 illustrates a process of verifying network name authenticity in accordance with embodiments of the invention.

FIG. 3 illustrates a process of gathering relative features for a given principal in accordance with embodiments of the invention.

FIG. 4 illustrates a process of gathering semantic features of a principal in accordance with embodiments of the invention.

FIG. 5 illustrates a typical computing system that may be employed to implement processing functionality in embodiments of the invention.

### DETAILED DESCRIPTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention has been described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

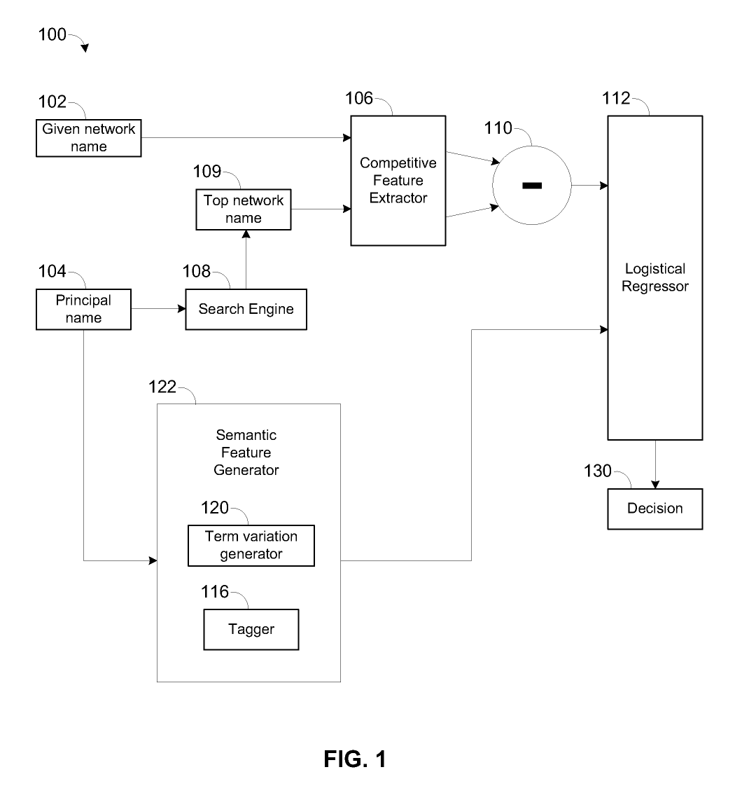

FIG. 1 illustrates a network name authenticity verifier in accordance with embodiments of the invention. The name authenticity verifier 100 determines whether a given network name 102 is an authentic network name for a principal identified by a principal name 104. The authenticity verifier 100 generates a probability 130 that the given network name 102 is an authentic network name for the principal. In one example, the probability 130 is a value between 0 and 1, and a value greater than 0.5 indicates that the given network name 102 is an authentic network name for the principal. The authenticity verifier 100 uses a logistic regressor 112 to produce the probability 130. The regressor 112 may be trained on initial training data as an initialization step. Subsequent to initialization, the name authenticity verifier 100 receives a given network name 102 and a principal name 104, invokes a search engine 108 on the principal name to determine a top network name 109, submits the given network name and the top network name 109 to a feature extractor 106.

The feature extractor 106 may use a database of search engine data, referred to herein as WebMap, which includes attributes of the URL and of the web page(s) referred to by the URL. The attributes may include, for example, click history, link topology, and other properties of the web page referred to by the URL

The feature extractor 106 selects, i.e., retrieves, a first set of competitive features that correspond to the given network name, and selects a second set of competitive features that correspond to the top name. The feature extractor 106 retrieves statistics related to the input URL (the given URL 102 or the top URL 109). The statistics may include, for example, the number of clicks on the URL, the number of inbound links, and the like. A URL having more clicks and inbound links than another URL is more likely to be the official or authentic URL than the other URL. The feature extractor 106 uses the top network name 109 to normalize the given network name 102, because it is generally not clear how many clicks are enough to verify that a page is an official page, or how many inbound links are enough to verify an official page. The feature extractor 106 is illustrated as having two parallel inputs primarily for illustrative purposes. In other examples, the feature extractor 106 may receive a single input and produce a single output (the features that correspond to the input name), and may be applied sequentially to the network name 102 and the top URL.

A feature comparison operator 110 generates a set of relative features, which represent a relative difference between the first and second sets of competitive features. The relative features are provided to the regressor 112 for use in generating the probability 130. Multiple different types of feature comparison operators 110 may be used, including a simple difference, a normalized difference, and a log difference. The input to the feature comparison operator 110 may be represented as a pair of values (fj1, fj0), where fj1 is the jth feature of the user input document (1) and fj0 is the jth feature of the top ranked document (0). The specific type(s) of feature comparison operator 110 that are used may be selected based on configuration options or otherwise determined by a particular implementation of the verifier 100.

Referring to FIG. 1, as stated above, the name verifier 100 determines a probability 130 that a given network name 102 is an authentic, e.g., officially registered or recognized, network name of a principal identified by a principal name 104. The network name 102 may be, for example, a Uniform Resource Locator (URL), and the principal name 104 may be, for example, a business name, in which case the name verifier 100 determines a probability that the URL is the authentic URL for the business name.

In one example, in which the network name is a URL, the name verifier 100 sends the principal name 104 to a search engine 108 to retrieve a top URL, which is the highest-ranking search result generated by the search engine in a search for the principal name 104. This operation may produce a canonical, i.e., definitive or most commonly used, form of the URL. The search engine 108 may be, for example, a World Wide Web search engine such as that provided by Yahoo! Inc., in which case the top URL is the highest-ranking (i.e., best match) URL found by the search engine 108 in a search of the World Wide Web. The top URL is sent to a feature extractor 106, which produces one or more features, e.g., name-value attributes, associated with the top URL. The feature extractor 106 may retrieve feature information from, for example, the WebMap database of feature information described above. The properties may be generated by the search engine 108, for example. The network name 102 is a “given” network name that is sent directly to the feature extractor 106, and in this example is a given URL. The feature extractor 106 produces one or more features associated with the network name 102. The output of the feature extractor 106 includes the features of the top URL, e.g., properties of the web page referred to by the top URL, and the features of the given URL, e.g., properties of the web page referred to by the given URL. The feature comparison operator 110 receives the two competitive sets produced by the feature extractor 106 and generates a set of relative features, which represent a difference between the first and second sets of competitive features.

In the URL case, the feature extractor 106 includes the WebMap component, which in turn includes feature induction modules, such as a click engine, query log analyzer, and spam detector. The modules are able to provide descriptive and discriminative features in real time. Those features may be, for example, trained non-linear functions of simple arguments, such as word or term statistics, Web page link topology, user session information, user click behavior, time stamps, regions, and the like. The features may include click features, which record the click information about a URL, such as a click ratio that represents the ratio of the number of clicks on a particular URL for a query to the total number of clicks for the query. The features may also include Document features, e.g., measures of document quality, such as number of misspelled terms or words, document length, spam scores, and the like. The features may further include web link topology features that indicate, for example, how well a web page is recognized through the World Wide Web. For example, one topology feature is entropy of in-bound link distribution, which is basically the histogram of inbound anchor text of the destination URL. If a URL is referred to by the same anchor text from numerous links, the URL is likely to contain good content. Other link structure features may be calculated based on, for example, the diversity of hosts, and the like.

In other examples, in which the network name 102 may be, for example, a host name or an e-mail address, the feature extractor may perform additional processing to extract a particular type of data from the result of the search engine 108. The feature extractor 106 produces attributes relevant to the type of network name. As a simple example, if the network name 102 is a host name, then the feature extractor may use the host name portion of the top URL to look up and extract features relevant to the host name portion from the WebMap and/or search engine index, or from some other database of host name properties. As another example, if the network name 102 is an e-mail address, then the feature extractor may use an e-mail address found on the web page referred to by the top URL to look up and extract features relevant to the e-mail address from a database of e-mail information, such as mail logs. WebMap provides information such as the page quality, the topology of the page (inbound and outbound links, click information, and the like). In another example, the search engine 108 may search an online address book, directory service, or database of e-mail addresses instead of or in addition to searching the World Wide Web.

In one example, semantic features may be used to enhance the accuracy of the verifier 100. If, for example, the principal name is a business name, then the business's location is a possible semantic feature. In one example, a set of semantic features is generated by a semantic feature generator 122 based upon the principal name 104. The semantic feature generator 122 provides the semantic features to the regressor 112 and to the feature extractor 106. The semantic features are, for example, features that have meanings related to the type of entity represented by the principal name 104. Semantic features may be of at least three types: vertical knowledge based features, term variations (i.e., synonyms), and semantic page matching features. The semantic feature generator 122 retrieves the semantic features from databases or generates the features according to rules described below.

Vertical knowledge refers to data that contains information in fields. For example, US city-state pairs and US business names may be collected in a vertical knowledge base. Vertical knowledge, e.g., a business's location, may be retrieved from a database of business information, such as a database of local businesses in a geographical area as provided by Yahoo! Local, or an online directory service, contact list, or telephone directory.

One approach to using vertical knowledge is to explicitly label, i.e., tag or annotate, terms in business names that are submitted in queries. For example, occurrences of a city name and occurrences of a state name may be tagged using city and state tags, respectively, using a tagger 116. Features may also be generated to indicate whether a city is in a state and whether a city name is unique or exists in multiple states. Our experiments show that location terms or words play an important role in verifying an official URL.

Another vertical knowledge-based approach involves identifying key terms in a business name in an inexplicit way. A key term may refer to a business brand. A language model is built on a collection of US business names from various resources. The language model includes unigrams (frequencies of single words), bigrams (frequencies of two consecutive words), and trigrams (frequencies of three consecutive words) as the inexplicit features. The unigrams, bigrams, and trigrams are generated from a particular corpus of text. Unigrams that occur with low frequency in the collection of business names have higher probabilities of being business brands, such as “Verizon”, “Fidelity”, and the like. High-frequency unigrams and bigrams are more likely to be categories, such as “LLC”, “bank”, “school”, “school district”, and the like. The unigrams, bigrams, and trigrams form the inexplicit features. In one example, the unigrams, bigrams, and trigrams are generated and their corresponding frequencies are added as features. In other examples, a subset of the unigrams, bigrams, and trigrams is generated and added as features.

The use of synonyms in documents and queries for higher recall in information retrieval is known to those skilled in the art. Each user input business name may be considered to be a query, in which case the query can be classified as a navigational query. However, synonyms should be introduced with caution in navigational and entity queries so that user intent and the precise meaning of the query is retained. In one example, the term variation generator 120 generates synonyms as follows. Three examples of synonyms for business name canonicalization that introduce little risk and provide substantial performance improvement are as follows. One synonym type includes a business name's possessive and plural forms. For example, “gray's appliance” and “grays appliance” are synonyms. Another synonym type is location variation. For example, “tx” may be distinguished a synonym for Texas. A third synonym type is business type and category variation. For example, “LLC”, a synonym for “Limited Liability Company”, “clinic”, “hospital”, and “medical center” may all be synonyms.

Candidate generation for synonyms is not a trivial problem, especially when synonyms extend beyond morphological variations. Three different synonym generation approaches are described herein, corresponding to the three types of synonyms introduced above.

For business type and categories, corpus analysis is used to generate synonym candidates. The corpus analysis is based upon word distributional similarity, which is used because true variants tend to be used in similar contexts. In the distributional word similarity calculation, each word is represented with a vector of features derived from the content of the word. The trigrams to the left and right of the word are used as the word's context features by mining a large Web corpus. The similarity between two words is the cosine similarity between the two corresponding feature vectors. In one example, expansion is limited to terms and term groups that have high frequency and those whose synonyms have high frequency in the business name database. Thresholds are used on the frequency so that expansion is limited to terms for business type and business category, while retaining the brand and location.

A dictionary-based approach is used to address location variations, since the vocabulary is limited. City and state pair dictionary is used to disambiguate some abbreviated state names. Possessives and plural pairs are recognized using a regular expression based approach to generate expansion candidates, and expansion candidates that have high distributional similarity scores are selected.

In one example, semantic matching involves matching a document against query semantic tags, e.g., city, state, business brand, category, and the like, in contrast to word or phrase matching. Richer information can be obtained with semantic matching. Semantic matching indicates when a term or phrase is matched, and also whether the document contains the key location, the brand, and their frequencies. For example, the frequency of an item in a document, in term or phrase matching, is positively correlated with the probability that the document is a good match with the query. However, in some cases, the number of occurrences of a matching term or phrase is not positively correlated with the probability that the document is a good match. For example, the frequency of a business's location (i.e., address) may be negatively correlated with the probability that the document is an official document of a business name. Such semantic information has been found to significantly improve accuracy. The semantic matching features described herein count a variety of matches against each semantic concept. Example semantic features include how many times a document's inbound anchor text matches a city name. A semantic concept is counted as a feature instead of a word or term because the concept may contribute additional information about the probability that a page is a strong match, i.e., an official page of the given business name. For example, although the state name “Georgia” is a popular term in both a business name corpus and the Web corpus, the state name “Georgia” is more likely to be a brand of the business in the business name “Georgia Department of Health.” The term “Georgia” is likely to be useful in providing discriminative information in separating the page from the same type of business in a different state. That is, “Georgia” is a key term in the business name. However, implicit semantic features, such as in a business name language model, do not represent “Georgia” in this example as part of a business name, because “Georgia” is a high-frequency term that is not easily recognized as a business name.

As described above, the frequency of a location address in document text has been found to be negatively correlated with the probability that the page is the official page of the business, which is contrary to the result that would be produced by normal term based on matching features and the target probability. The presence of high-frequency occurrences of locations matching the body text of a page is a strong indicator that the page is an aggregation page, e.g., a directory or yellow pages page, instead of an official page for the business. An official page, in contrast, often has at most one location address.

Once the semantic features, including semantic matching features, vertical knowledge based features, and term variations, have been determined, they are provided to the regressor 112 as input. The regressor 112 performs logical regression to generate the probability 130. As known to those skilled in the art, logistic regression is a technique for constructing a function f, such as:

$${\sum }_{i} L ( f ( {X}_{i} ) , {y}_{i} )$$

that is to be minimized, where L is a logistic loss function, Xᵢ is a feature vector for a business name-URL pair, yᵢ=1 if the URL is an official URL of the corresponding business name, yᵢ=0 otherwise, as provided by training data. As an example, logistic regression may be implemented using a stochastic gradient boosting tree model or other models known to those skilled in the art.

Boosting methods construct weak classifiers using subsets of features and combine the subsets features by considering their prediction errors. Each feature is ranked by its related classification errors. The stochastic gradient boosting tree (SGBT) uses multiple randomly sampled data to induce trees, and ranks features by their linear combinations.

Authenticity of a network name 102 may be defined in several different ways, but, in one example, the authenticity of a network name 102 with respect to a principal name 104 is determined by whether the network name has been properly registered with some authority or database by or for the principal. In another example, the authenticity of the network name may be decided by the principal. For example, the URL www.yahoo.com is the authentic network name for the principal Yahoo! Inc. because www.yahoo.com has been registered with a domain name authority. As another example, the URL hr.yahoo.com may be adopted by the Human Resources group within Yahoo! Inc., but hr.yahoo.com may be either registered for the principal Yahoo! Inc. or not registered. The URL hr.yahoo.com is the authentic URL for the Human Resources group within Yahoo! Inc. in this example because that group recognizes the URL as its own (and because no other principal has a superior right). The URL www.yahoooo.com is not the authentic network name for Yahoo! Inc., because www.yahoooo.com is not registered by the principal Yahoo! Inc. or otherwise recognized by the principal as a valid URL for the principal. In other examples, the authentic name need not be registered, but instead is recognized by the principal or associated with the principal by some right, e.g., an unregistered trademark that identifies the principal or a product associated with the principal, or a chat handle name that a user commonly uses but has not registered. The term “network name” is used herein to refer to the name for which authenticity is to be determined, because that name refers to a resource on a computer network in a distributed computing system in some examples. However, the use of the term “network” does not necessarily require the network name to identify a resource on a computer network.

The name verifier has many uses, such as, for example, verifying that a given electronic mail address is an authentic electronic mail address of an individual or business, which may be done with appropriate changes to the features.

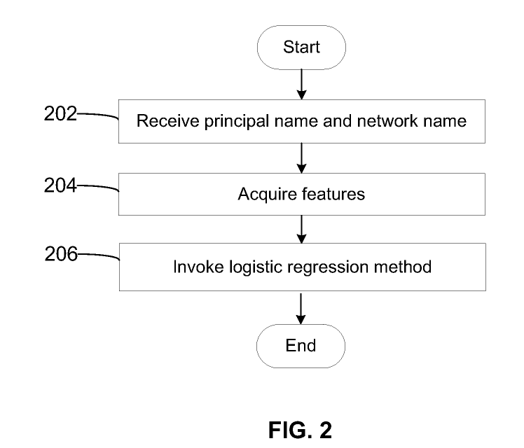

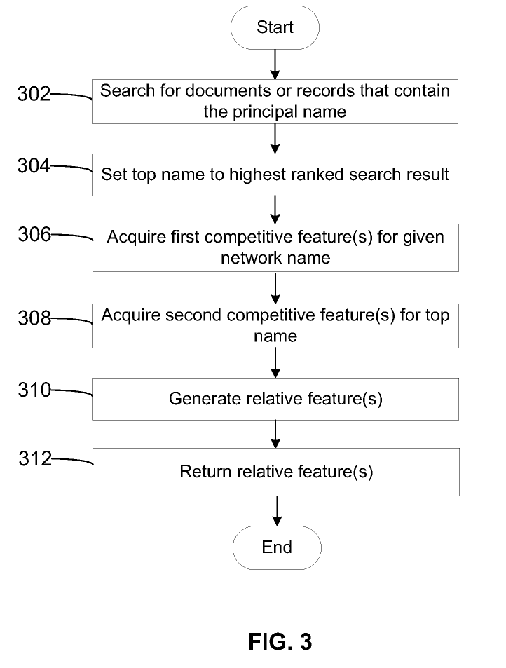

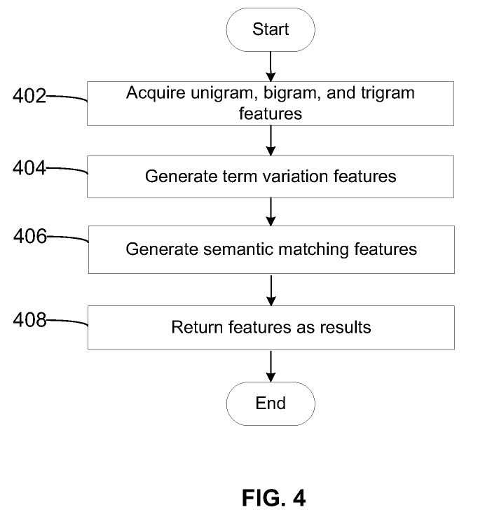

FIG. 2 illustrates a process of verifying network name authenticity in accordance with embodiments of the invention. Block 202 receives a principal name and a given network name. Block 204 gathers features of the principal name and network name using the processes of FIGS. 3 and 4. Block 206 applies a logistic regression method for the features to generate a probability that the given network name is an official network name for the principal.

FIG. 3 illustrates a process of gathering relative features for a given principal in accordance with embodiments of the invention. Block 302 searches for documents or data records (e.g., web pages) that contain the business name. Block 304 receives the top, i.e., highest ranked, network name corresponding to a highest-ranked document produced by the search of block 302. The highest-ranked document may be identified by, for example, a URL for a web page. Block 306 acquires a first competitive feature that corresponds to the given network name, e.g., a feature of a web page referred to by a given URL. Block 308 acquires a second competitive feature that corresponds to the top document and therefore to the top network name 109, e.g., the top URL. Block 310 generates a relative feature by applying a feature comparison operator to the first and second competitive features. The relative feature represents a difference between the given network name and the top network name 109. Block 312 returns the relative feature as a result, suitable for use by, for example, the process of FIG. 2 as input to a logical regression method.

FIG. 4 illustrates a process of gathering semantic features of a principal in accordance with embodiments of the invention. Block 402 acquires unigram, bigram, and/or trigram information for a principal (e.g., business) name from a local information database and makes that information available as semantic feature attributes. Block 404 generates term variations for the principal name and makes the term variations available as semantic feature attributes. In one example, synonyms are used as an equivalent case of the original term when matching features are calculated. For example, if the query is “ca dmv”, then either “ca” or the synonym “California” will be matched in a document. Both synonyms correspond to a single California attribute. Block 406 generates semantic matching features, such as the frequency of occurrence of a location name in a web page. Block 408 returns the semantic feature as a result, suitable for use by, for example, the process of FIG. 2 as input to a logical regression method.

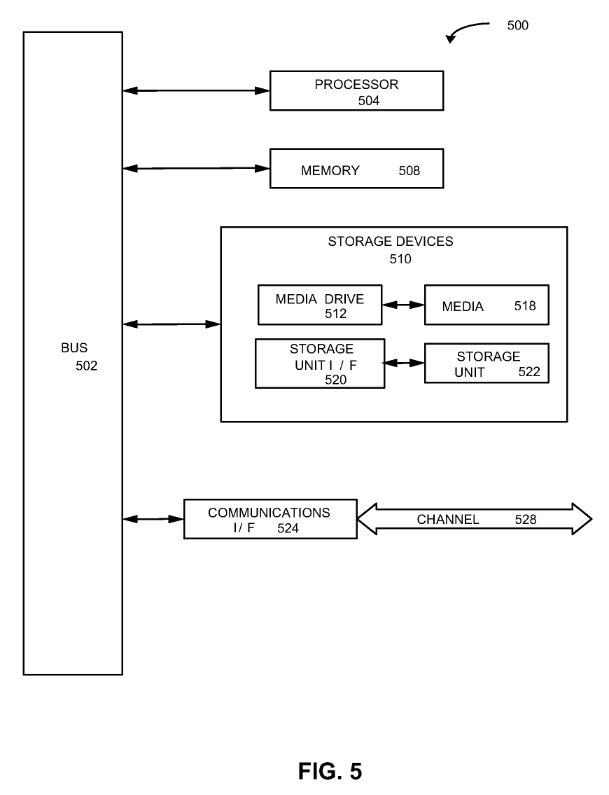

FIG. 5 illustrates a typical computing system 500 that may be employed to implement processing functionality in embodiments of the invention. Computing systems of this type may be used in clients and servers, for example. Those skilled in the relevant art will also recognize how to implement the invention using other computer systems or architectures. Computing system 500 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 500 can include one or more processors, such as a processor 504. Processor 504 can be implemented using a general or special purpose processing engine such as, for example, a microprocessor, microcontroller or other control logic. In this example, processor 504 is connected to a bus 502 or other communication medium.

Computing system 500 can also include a main memory 508, such as random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (“ROM”) or other static storage device coupled to bus 502 for storing static information and instructions for processor 504.

The computing system 500 may also include information storage system 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518, may include, for example, a hard disk, floppy disk, magnetic tape, optical disk, CD or DVD, or other fixed or removable medium that is read by and written to by media drive 514. As these examples illustrate, the storage media 518 may include a computer-readable storage medium having stored therein particular computer software or data.

In alternative embodiments, information storage system 510 may include other similar components for allowing computer programs or other instructions or data to be loaded into computing system 500. Such components may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524 are in the form of signals which can be electronic, electromagnetic, optical or other signals capable of being received by communications interface 524. These signals are provided to communications interface 524 via a channel 528. This channel 528 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 508, storage device 518, or storage unit 522. These and other forms of computer-readable media may be involved in storing one or more instructions for use by processor 504, to cause the processor to perform specified operations. Such instructions, generally referred to as “computer program code” (which may be grouped in the form of computer programs or other groupings), when executed, enable the computing system 500 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 500 using, for example, removable storage drive 514, drive 512 or communications interface 524. The control logic (in this example, software instructions or computer program code), when executed by the processor 504, causes the processor 504 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

Although only certain exemplary embodiments have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A computer-enabled method comprising:
receiving a principal name and a given network name;
receiving at least one feature attribute from at least one database of feature attributes, wherein the at least one feature attribute comprises a characteristic of the principal name, a characteristic of the network name, or a combination thereof; and
invoking a logistic regression method to generate a probability, based upon the at least one feature attribute, that the given network name is an official network name for the principal name.

2. The method of claim 1, wherein the network name comprises a Uniform Resource Locator and the principal name comprises a name of a business.

3. The method of claim 1, wherein the logistic regression method comprises a gradient boosting tree model that generates the probability based upon the at least one feature attribute.

4. The method of claim 1, wherein receiving at least one feature attribute comprises:
causing a search engine to search for at least one document that includes the principal name;
receiving a top network name from the search engine, wherein the top network name comprises a top-ranked document selected from the at least one document that includes the principal name;
generating the at least one feature attribute based upon application of a feature comparison operator to at least one first competitive feature that corresponds to the given network name and at least one second competitive feature that corresponds to the top network name.

5. The method of claim 4, wherein the at least one first competitive feature and the at least one second competitive feature each comprise a page quality score, a spam score, a word score, or a combination thereof.

6. The method of claim 4, wherein the at least one first competitive feature comprises a click feature, a document feature, a web link topology feature, or a combination thereof.

7. The method of claim 6, wherein the click feature comprises a click ratio of the number of clicks on a particular network name for a query to the total number of clicks for the query.

8. The method of claim 6, wherein the document feature comprises a measure of document quality, a number of misspelled words, a length of the document, a spam score of the document, or a combination thereof.

9. The method of claim 6, wherein the web link topology feature comprises the entropy of an inbound link distribution, wherein the distribution comprises a histogram of inbound anchor text of a destination network name.

10. The method of claim 1, wherein receiving at least one feature attribute comprises:
receiving unigram information, bigram information, trigram information, or a combination thereof, for the principal name from a local information database; and
generating the at least on feature attribute based upon at least one of the unigram, bigram, or trigram information.

11. The method of claim 1, wherein receiving at least one feature attribute comprises:
receiving at least one semantic feature, wherein the at least one semantic feature comprises a vertical knowledge feature, a term variation, a semantic matching feature, or a combination thereof; and
generating the at least on feature attribute based upon the at least one semantic feature.

12. A computer-enabled method comprising:
receiving a principal name and a given network name;
causing a search engine to search for at least one document that includes the principal name;
receiving a top network name from the search engine, wherein the top network name comprises to a top-ranked document selected from the at least one document that includes the principal name;
generating at least one relative feature based upon application of a feature comparison operator to at least one first competitive feature that corresponds to the given network name and at least one second competitive feature that corresponds to the top network name;
determining at least one semantic feature of the principal name; and
invoking a logistic regression method to generate a probability, based upon the at least one relative feature and the at least one semantic feature, that the given network name is an official network name for the principal name.

13. The method of claim 12, wherein the logistic regression method comprises a gradient boosting tree model that generates the probability based upon the relative and semantic features.

14. The method of claim 12, wherein the at least one first competitive feature and the at least one second competitive feature each comprise a page quality score, a spam score, a word score, or a combination thereof.

15. The method of claim 12, wherein determining at least one semantic feature of the principal name comprises:
receiving the at least one semantic feature, wherein the at least one semantic feature comprises a vertical knowledge feature, a term variation, a semantic matching feature, or a combination thereof.

16. A network name verification apparatus, comprising:
logic operable to receive a principal name and a given network name;
logic operable to receive at least one feature attribute from at least one database of feature attributes, wherein the at least one feature attribute comprises a characteristic of the principal name, a characteristic of the network name, or a combination thereof; and
logic operable to invoke a logistic regressor to generate a probability, based upon the at least one feature attribute, that the given network name is an official network name for the principal name.

17. The apparatus of claim 16, wherein the network name comprises a Uniform Resource Locator and the principal name comprises a name of a business.

18. The apparatus of claim 16, wherein the logistic regression method comprises a gradient boosting tree model that generates the probability based upon the at least one feature attribute.

19. A computer-readable medium comprising instructions for annotating a first collection of documents with semantic tags, the instructions for:
receiving a principal name and a given network name;
receiving at least one feature attribute from at least one database of feature attributes, wherein the at least one feature attribute comprises a characteristic of the principal name, a characteristic of the network name, or a combination thereof; and
invoking a logistic regression method to generate a probability, based upon the at least one feature attribute, that the given network name is an official network name for the principal name.

20. The computer-readable medium of claim 19, wherein the network name comprises a Uniform Resource Locator and the principal name comprises a name of a business.

21. The computer-readable medium of claim 19, wherein the logistic regression method comprises a gradient boosting tree model that generates the probability based upon the at least one feature attribute.
